(19) United States
(12) Patent Application Publication
(10) Pub. No.: US 2013/0048427 A1
(43) Pub. Date: Feb. 28, 2013

(54) Portable ladder

(71) Applicant: Pietro Sordo, Rosa (Vicenza) (IT)

(72) Inventor: Pietro Sordo, Rosa (Vicenza) (IT)

(73) Assignees: Pietro SORDO, Rosa (Vicenza) (IT); Luca Ferremi, Salo, Brescia (BS) (IT); Monica Siviero, Rossano Veneto (Vicenza) (IT)

(21) Appl. No.: 13/639,146

(22) PCT Filed: Mar. 28, 2011
(86) PCT No.: PCT/EP2011/001540

§ 371 Date: Oct. 3, 2012

(30) Foreign Application Priority Data
May 10, 2010 (IT) VI2010U000023

(51) Int. Cl. E06C 7/46

(52) U.S. Cl. 182/110

(57) ABSTRACT

A portable ladder is provided having at the base end of at least one of the uprights thereof a plurality of sucker elements, adapted to adhere strongly to the ground following the formation of vacuum beneath the elements. The ladder has at the base of the at least one upright a structure, which includes a cap, at the concave surface of the cap facing towards the surface on which the ladder rests there is fixed the plurality of sucker elements.

The present model regards a portable ladder, according to the general part of claim 1.

It is known that the portable ladders, used both at household and professional level, for example by electricians, plumbers and artisans in general, are often of the type having a single pair of parallel uprights, connected by a series of equally spaced transverse bars, on which the foot of the ascending person steps.

Also known are ladders of the portable type defined “foldable”, constituted by a simple ladder, hinged at the upper end thereof, with a frame substantially of the same length thereof; by opening, such ladder is capable of supporting itself on any floor or surface in general, without requiring further supports. Foldable ladders are always provided with means that prevent an excessive spreading apart between the actual ladder and the framework mentioned above; furthermore, such ladders are almost always such to have a shelf, which is arranged horizontally when the ladder is open, such shelf resting on the last bar of the ladder itself.

In order to prevent dangerous accidents for the user, it is generally provided for that at the lower ends of the uprights of the portable ladders there be provided rubber elements or however elements that increase the friction present between said ends and the surfaces that support the ladder, with the evident object of guaranteeing the stability of the ladder.

Unfortunately, sometimes these solutions are not sufficient and, in particular situations, the ladder slides, with the consequences that sometimes expose the user to danger.

The following documents can be mentioned as examples of the state of the art: GB-A-144.040; DE 20310659 UI; GB-A-1098518; GB-A-2435069.

Some of the previously mentioned documents are actually outdated, some dating back to the early '900, but they actually did not have a great commercial development, apparently due to their poor practicality and/or their high cost thereof. With the aim of overcoming such drawbacks, the applicants of this utility model described a foldable ladder in the Italian invention patent no 1307071.

The object of the present model is to provide a portable ladder, also provided—at the ends of the uprights thereof—with elements capable of strongly adhering to the ground during operation, which is provided with functional and constructive characteristics such to allow them to overcome the aforementioned drawbacks. In particular, in order to obtain such result, the portable ladder according to the model provides for that, at the base of at least one of the uprights thereof, there be a structure, comprising a cap, at whose concave surface, facing towards the surface on which the ladder rests, a plurality of sucker elements is fixed. Above the cap a substantially parallelepiped-shaped configuration is arranged, which ends up at the lower part with the concave surface adapting to that of the underlying cap. The end of one of the uprights of the portable ladder can thus be fixed to such element.

These and other characteristics of the model shall now be described hereinafter in detail, with reference to a particular embodiment, provided by way of non-limiting example, with the help of the attached drawings, where:

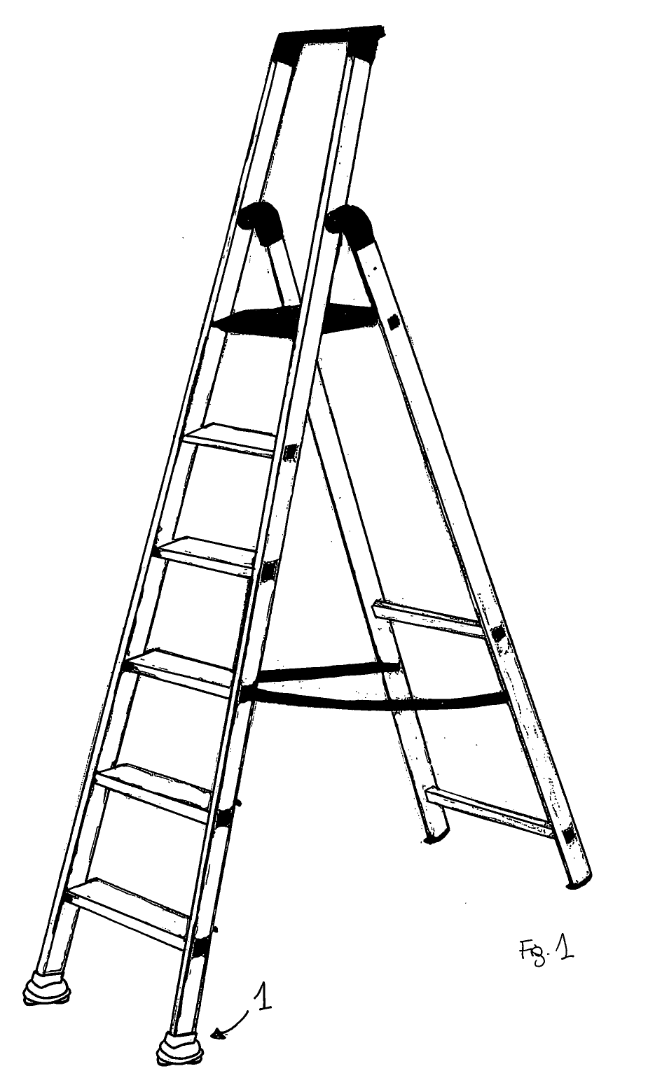

FIG. 1 illustrates an overall view of a ladder according to the model;

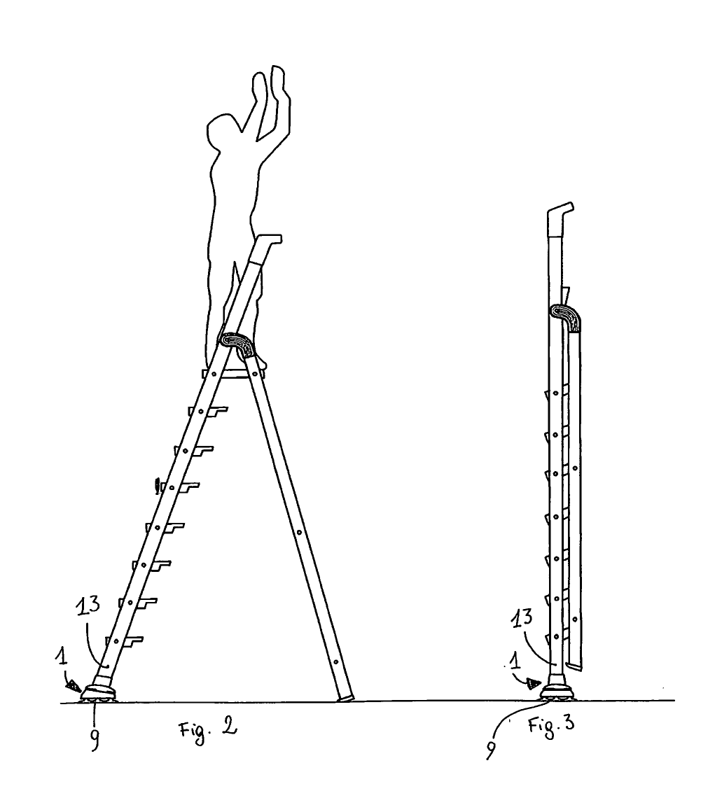

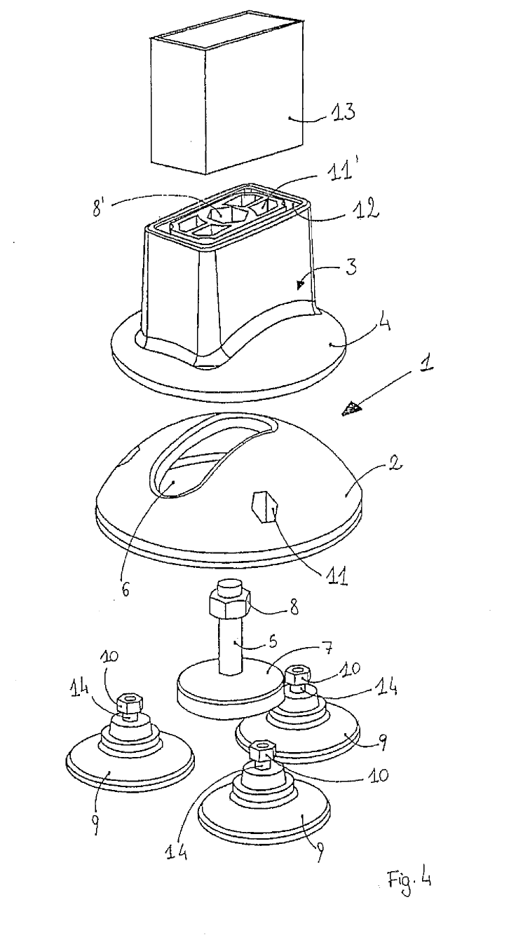

FIGS. 2 and 3 illustrate a lateral view of the ladder according to the model, respectively in operating position and inoperative condition, once folded;

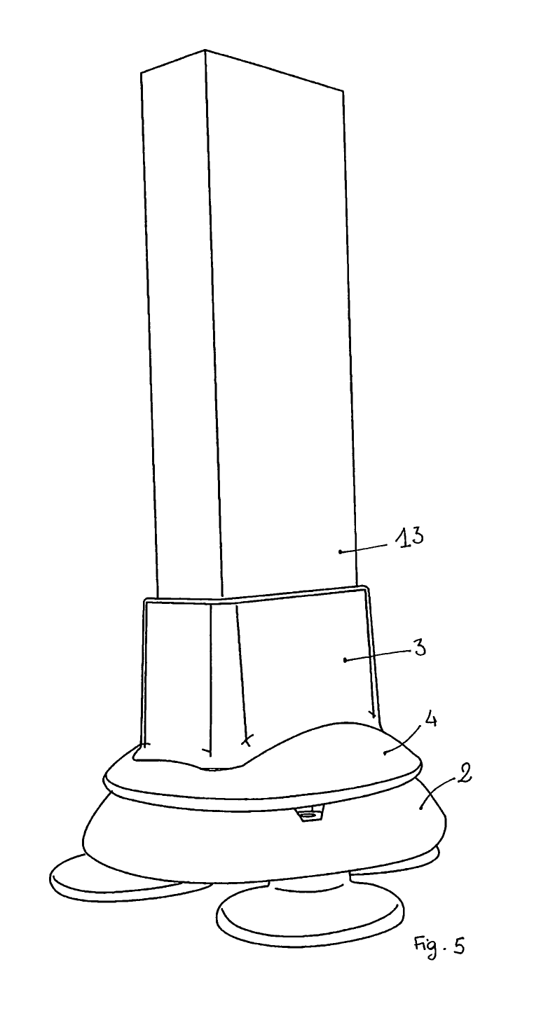

FIG. 4 illustrates the structure present at the base of the uprights of the ladder according to the model;

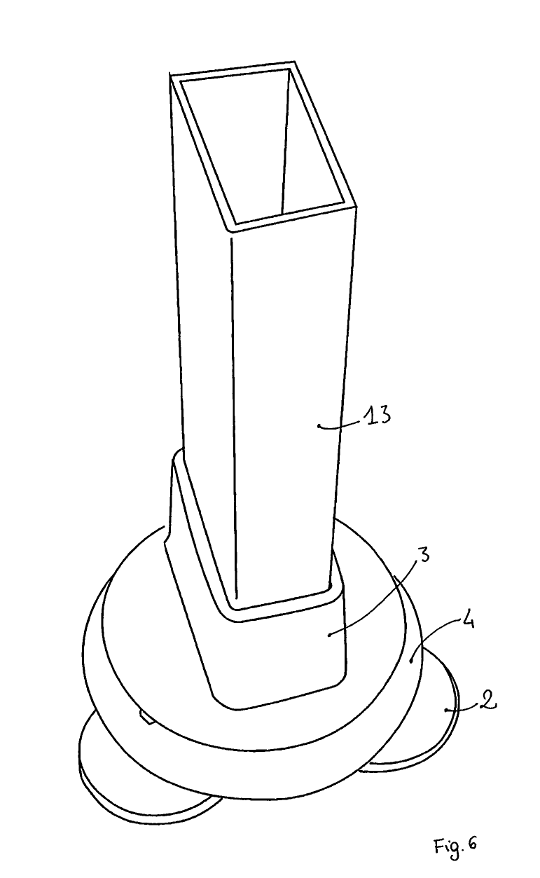

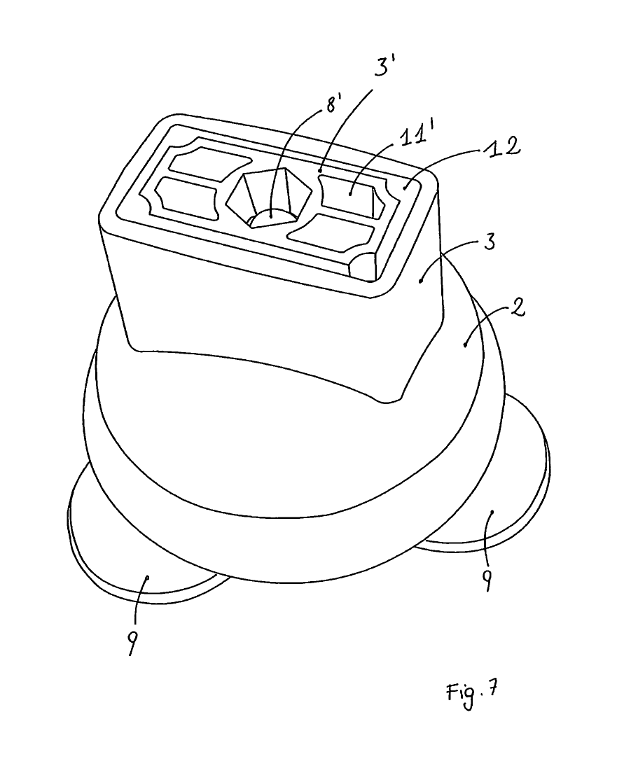

FIGS. 5 and 6 respectively represent a lateral and elevational view of the lower part of one of the uprights of the ladder according to the model;

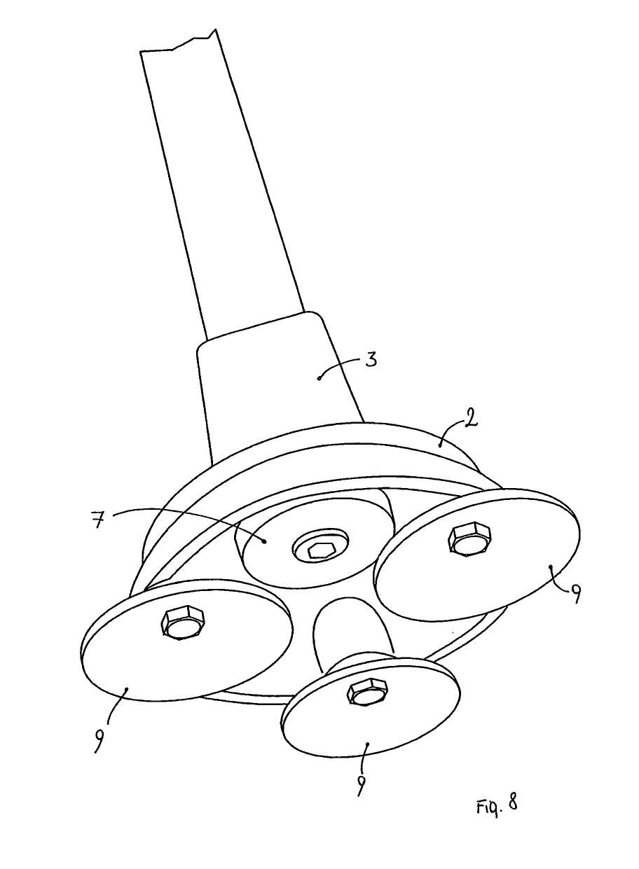

FIG. 7 represents a top view of the structure present at the lower part of the uprights of the ladder according to the model;

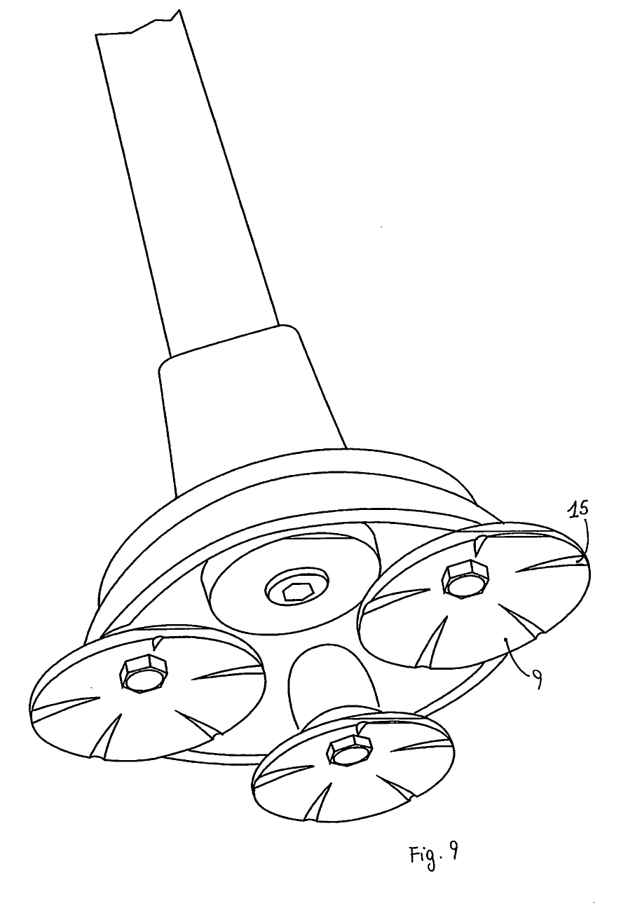

FIG. 8 represents a bottom view of the lower part of said structure;

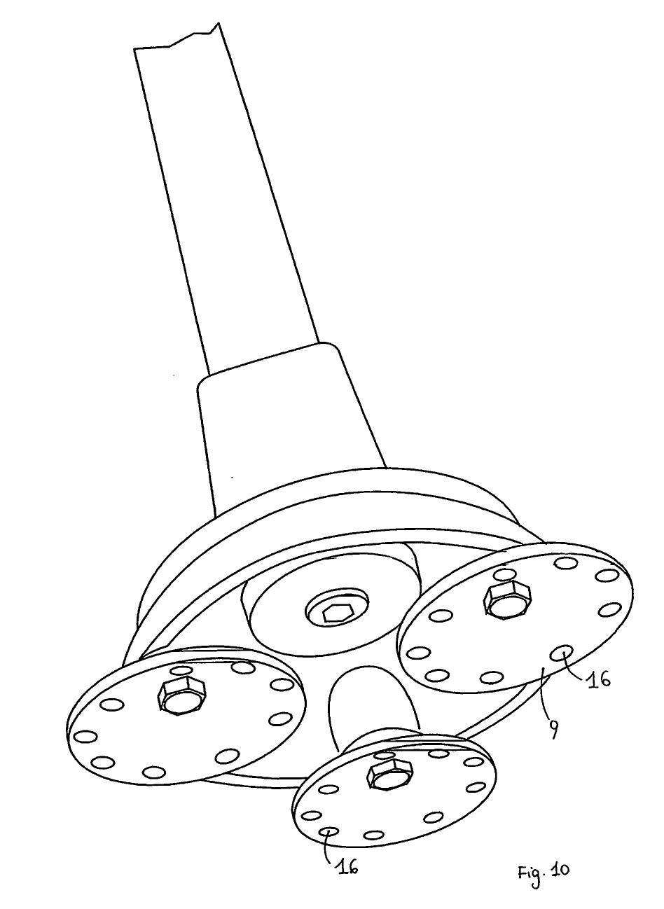

FIGS. 9 and 10 represent two possible construction variants of the elements present in the previously mentioned structure.

As observable in FIGS. 1 to 3 the ladder according to the model can be of the so-called foldable type, as illustrated in the figures, or it can be of the simple type with two uprights mutually coupled by transverse bars.

According to the model, it is provided for that at the ends 13 of two uprights thereof (in this case being a foldable ladder, uprights to which bars are fixed) there be present a structure 1 at whose lower surface, positioned at the floor supporting the ladder, a plurality of sucker elements 9 is provided, which are susceptible to strongly adhere to the ground following the formation of vacuum beneath said elements, all being provided according to per se known means.

The novelty characteristic of the model in particular lies in the configuration of such structure 1 which, as observable particularly in FIG. 4, comprises a cap 2, at whose concave surface, facing towards the surface on which the ladder rests, a plurality of sucker elements 9 is fixed.

Vice versa, above the cap an element 3 is arranged with substantially parallelepiped-shaped configuration, which terminates at the lower part with a concave surface 4, which adapts to that of the underlying cap 2. The end 13 of one of the uprights can be fixed to such element 3.

The elements described above are also particularly visible in FIGS. 5 and 6.

Still as observable from FIG. 4, the cap 2 is fixed to the element 3 by means of a pin 5, which is inserted into an extended slit 6, present at the top of the cap, with the possibility of the pin sliding in said slit. The pin is internally prevented from slipping off from the cap by the presence of an element 7, advantageously disc-shaped, with transverse dimension adapted to prevent insertion thereof into the slit 6. Vice versa, at the inner threaded end of the pin 5 there is a bolt 8, which is arranged beneath the cap 2.

In particular a first longitudinal conduit 8′ is provided, within which the bolt 8 is adapted to be inserted, which remains blocked therein once inserted. In practice, the pin 5 remains integral with the element 3, upon completing mounting; due to the presence of the extended slot 6, it is possible to provide a mutual angular movement between the element 3 and the upright 13 integral therewith with respect to the cap 2, to which the sucker elements 9 are fixed on the other hand. In particular, in order to obtain this fixing, said suckers 9 are integral with pins 14, to whose upper ends bolts are fixed, intended to be inserted into special holes 11, shaped identically, present in the cap 2.

As observable in particular in FIG. 7, it can be seen that in the element 3 there is an inner part 3′, within which in particular the conduit 8′ mentioned previously is provided. This part 3′ is separated from the outer surface of the element 3 by an annular seat 12. Within said seat, one of the ends 13, internally hollow, of one of the ladder uprights is adapted to be inserted, which thus terminates inserted between the outer surface of the element 3 and inner part 3′ thereof, remaining blocked therein. Advantageously, the inner part 3′ has longitudinally arranged conduits 11′ which may vary in number and shape. The object of the presence of these conduits 11′ is that of allowing a given deformability of the volume and of the inner part 3′, so as to allow an easy insertion of the end of the upright into the annular seat 12.

In FIG. 9, it is observable that, with the aim of improving the sealing of the sucker elements 9 it is possible to provide for grooves 15 arranged substantially radially, which depart from the edge of said sucker elements, up to almost reaching the central part of the sucker element. Alternatively, at the lower surface of the sucker elements 9, there may be projections 16 having low thickness. Conducted tests revealed that these two particular embodiments allow obtaining an increase of the adhesion force of the sucker elements with the underlying support surface, hence facilitating the stability of the ladder.

It should be pointed out that the structure 1, in the various embodiments thereof may also be used on ladders different from the one illustrated and described. In particular, such structure may be used in extensible, support and industrial ladders.

1-8. (canceled)

9. A portable ladder of the type having uprights wherein at a base end of said uprights a plurality of sucker elements are provided adapted to strongly adhere to the ground following formation of a vacuum beneath the sucker elements, said portable ladder including a structure (1) provided at the base end (13) of at least one of said uprights, said structure (1) comprising:
a cap (2) having a concave surface facing towards a surface on which said ladder rests and including a plurality of sucker elements (9) fixed to said concave surface, a top part of said cap having an elongated slot (6) formed therein;
an element (3) with a substantially parallelpiped configuration arranged above said cap (2) and having at a lower part a concave surface (4) complementary to said cap; and
a pin (5) extending from said element (3) through said elongated slot (6) of said cap (2) for sliding movement therein having a disc shaped element (7) at a first end thereof below said slot, said disc shaped element (7) having a transverse dimension so as to prevent insertion thereof into said slot, whereby said cap (2) is thereby fixed to said element (3),
wherein said base end (13) of said at least one of said uprights of said ladder is fixed to said element (3).

10. The ladder according to claim 9, wherein said element (3) includes a longitudinal conduit (8′) housing a threaded nut (8) which remains blocked therein once inserted into said longitudinal conduit, and said pin (5) is threadedly engaged with said nut at a second end of said pin.

11. The ladder according to claim 9, wherein said sucker elements are fixed to said cap (2) by means of pins (14) at upper ends of which nuts (10) are fixed.

12. The ladder according to claim 9, wherein said element (3) has lateral walls which are internally surrounded by an annular seat (12), and said base end (13) of said at least one of said uprights of said ladder is internally hollow and adapted to be inserted within said seat.

13. The ladder according to claim 12, wherein said element (3) includes longitudinal conduits (11′) which upon insertion of said end (13) of said at least one of said uprights of said ladder into said seat (12) permits deformation of a volume of an inner part (3′) of said element (3).

14. The ladder according to claim 9, wherein each of said plurality of sucker elements (9) includes grooves (15) arranged substantially radially on a lower surface thereof commencing at an edge of said sucker element and extending to near the center thereof.

15. The ladder according to claim 9, wherein each of said plurality of sucker elements (9.) includes a plurality of slight projections (16) provided on a lower surface of said sucker elements.

16. A device for mounting at a base end of one or more uprights of a portable ladder including a structure (1) comprising:
a cap (2) having a concave surface facing towards a surface on which said ladder rests and including a plurality of sucker elements (9) fixed to said concave surface, a top part of said cap having an elongated slot (6) formed therein;
an element (3) with a substantially parallelpiped configuration arranged above said cap (2) and having at a lower part a concave surface (4) complementary to said cap; and
a pin (5) extending from said element (3) through said elongated slot (6) of said cap (2) for sliding movement therein having a disc shaped element (7) at a first end thereof below said slot, said disc shaped element (7) having a transverse dimension so as to prevent insertion thereof into said slot, whereby said cap (2) is thereby fixed to said element (3).

17. The device according to claim 16, wherein said element (3) includes a longitudinal conduit (8′) housing a threaded nut (8) which remains blocked therein once inserted into said longitudinal conduit, and said pin (5) is threadedly engaged with said nut at a second end of said pin.

18. The device according to claim 16, wherein said sucker elements are fixed to said cap (2) by means of pins (14) at upper ends of which nuts (10) are fixed.

19. The device according to claim 16, wherein said element (3) has lateral walls which are internally surrounded by an annular seat (12) adapted to receive the base end of said one or more uprights of said portable ladder.

20. The device according to claim 19, wherein said element (3) includes longitudinal conduits (11′) which upon insertion of said base end of said one or more uprights of said portable ladder into said seat (12) permits deformation of a volume of an inner part (3′) of said element (3).

21. The device according to claim 16, wherein each of said plurality of sucker elements (9) includes grooves (15) arranged substantially radially on a lower surface thereof commencing at an edge of said sucker element and extending to near the center thereof.

22. The device according to claim 16, wherein each of said plurality of sucker elements (9) includes a plurality of slight projections (16) provided on a lower surface of said sucker elements.
